(19) United States
(12) Patent Application Publication
(10) Pub. No.: US 2002/0099312 A1
(43) Pub. Date: Jul. 25, 2002

(54) Massaging keyboard wrist rest

(76) Inventor: Jennifer Smith, Fort Worth, TX (US)

Correspondence Address: Law Offices of John D. Gugliotta, P.E., Esq., 202 Delaware Building, 137 South Main Street, Akron, OH, 44308, US

(21) Appl. No.: 09/768,120

(22) Filed: Jan. 23, 2001

(51) Int. Cl. A61H 7/00

(52) U.S. Cl. 601/131; 601/136

(57) ABSTRACT

A massaging keyboard wrist rest is provided having a supporting base structure, an upper surface having a series of aligned ball access orifices affixed to the base structure such that a plurality of aligned ball receiving cavities are formed at each said ball access orifice, and series of freely rotatable balls captively held in the ball receiving cavities. A bottom surface is affixed to the supporting base and forming a non-slip bottom surface.

### RELATED APPLICATIONS

The present invention was first described in Disclosure Document Number 480,143 filed on Oct. 03, 2000. There are no previously filed, nor currently any co-pending applications, anywhere in the world.

### BACKGROUND OF THE INVENTION

1. Field of the Invention

The present invention relates generally to attachments for guiding the hands of a typist and, more particularly, to wrist support incorporating a plurality of roller guides arranged thereon.

2. Description of the Related Art

In the not-too-distant future that one could envision the personal computer as a necessary appliance in every household. In fact, a large percentage of American households own at least one personal computer. As these numbers continue to increase, the market for computer accessories that enhance the usability of computers is growing as well. Perhaps the most well known of these accessories is the wrist support used on keyboards and more recently computer mice. These devices help hold the wrist at a proper angle thus reducing stress injuries such as carpal tunnel syndrome.

While wrist supports do an admirable job, many people find them annoying due to the constant friction they generate when the user slides their wrist across the surface. Additionally, they only provide support and do not provide any massaging action.

A search of the prior art did not disclose any patents that read directly on the claims of the instant invention; however, the following references were considered related.

The following patents disclose a wrist pad for use with keyboards having massaging means:

U.S. Pat. No. 5,839,992 issued in the name of Phillips

U.S. Pat. No. 5,718,655 issued in the name of Phillips

U.S. Pat. No. 5,348,408 issued in the name of Gelardi et al.

The following patents describe a padded apparatus for supporting arms and wrist of a computer user:

U.S. Pat. No. 5,183,230 issued in the name of Walker et al.

U.S. Pat. No. 5,158,256 issued in the name of Gross

U.S. Pat. No. 5,050,826 issued in the name of Johnston

U.S. Pat. No. 5,004,196 issued in the name of Gross

U.S. Pat. No. 5,792,081 issued in the name of Cross discloses a self-operated wrist massager with roller balls.

U.S. Pat. No. 4,973,176 issued in the name of Dietrich describes a portable wrist or forearm rest for a workstation.

Consequently, a need has developed for a device that addresses these shortcomings and provides ergonomic comfort for computer users.

### SUMMARY OF THE INVENTION

It is therefore an object of the present invention to provide an improved keyboard wrist rest.

It is a feature of the present invention to provide an improved wrist support incorporating a plurality of roller guides arranged thereon.

Briefly described according to one embodiment of the present invention, an ergonomic keyboard wrist rest is provided having a wrist support pad for use while operating a computer. The overall size of the wrist rest is approximately the same as a conventional padded keyboard support. However, instead of a synthetic top pad, the present invention utilizes a series of marble-sized balls which are captively held in a supporting base structure. The balls are free to rotate in any direction and thus users' hands can comfortably glide over the surface of the invention without the usual drag associated with a conventional wrist support pad.

An advantage of the rolling action of the balls is that they provide the user with a massaging action thus improving blood flow.

An advantage of a non-slip bottom surface is on the bottom of the invention prevents it from sliding around the desk-top.

The use of the present invention provides not only wrist support for users of any computer system, but it also provides massaging action as well, which may help reduce the severity of repetitive stress injuries.

An advantage of the present invention is that it can be used with any conventional computer keyboard.

Another advantage of the present invention is that it helps keep users hands in an elevated position. Such an elevated hand position reduces injury to wrist and associated muscles, may help reduce or eliminate effects of carpal tunnel syndrome, and increases relaxation and productivity while reducing stress and tension.

Advantages of the use of marble sized wooden balls that rotate freely including allowing users hands to glide effortlessly, provides massaging action, and improves blood flow.

### BRIEF DESCRIPTION OF THE DRAWINGS

The advantages and features of the present invention will become better understood with reference to the following more detailed description and claims taken in conjunction with the accompanying drawings, in which like elements are identified with like symbols, and in which:

FIG. 1 is a front perspective view of a massaging keyboard wrist rest according to the preferred embodiment of the present invention;

FIG. 2 is a top plan view thereof;

FIG. 3 a front elevational view thereof; and

FIG. 4 is a cross sectional elevational view taken along line IV-IV of FIG. 3.

### DESCRIPTION OF THE PREFERRED EMBODIMENTS

The best mode for carrying out the invention is presented in terms of its preferred embodiment, herein depicted within the Figures.

1. Detailed Description of the Figures

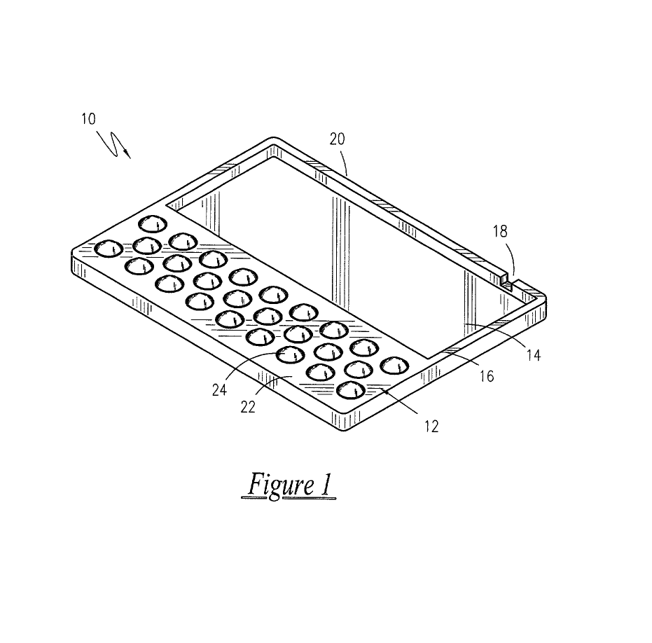

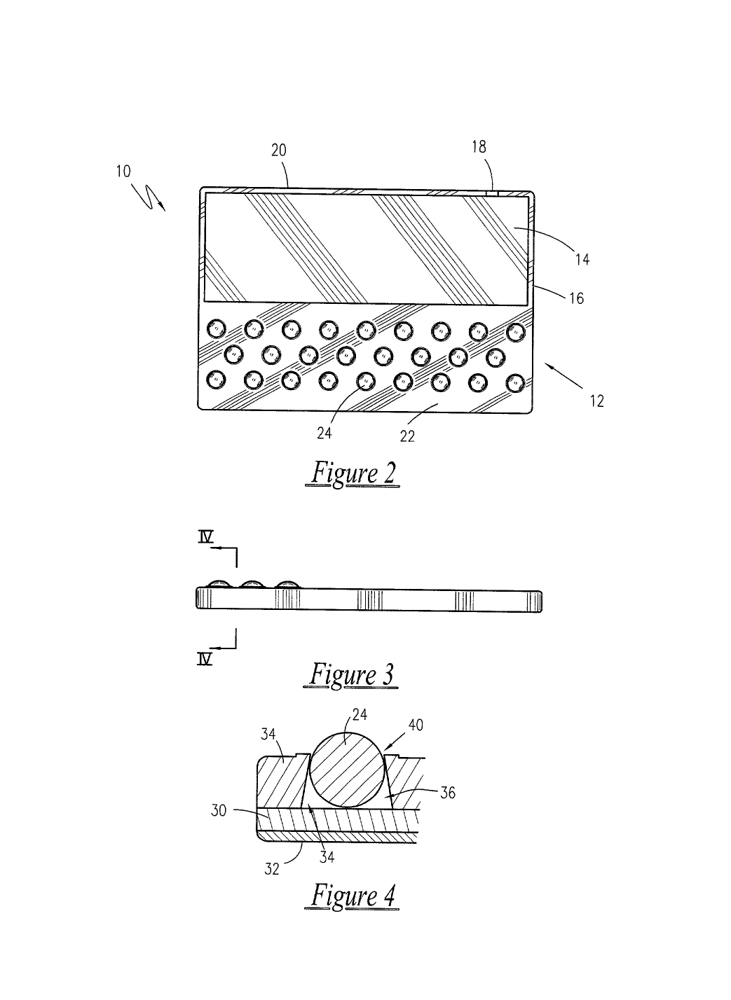

Referring now to FIG. 1, a massaging keyboard wrist rest 10 is shown, according to the present invention, having a wrist rest 12 laterally aligned with a keyboard holding tray 14. The keyboard holding tray 14 is circumscribed by a frame 16 for retaining an otherwise conventional computer keyboard. A cord egress channel 18 penetrates the rear fence 20.

The wrist rest 12 has an upper surface 22 including a series of marble-sized balls 24 which are captively held in a supporting base structure as will be described in greater detail below. The balls 24 are free to rotate in any direction and thus users' hands can comfortably glide over the surface 22 without the usual drag associated with a conventional wrist support pad.

Referring to FIG. 4, the supporting base structure is shown having a supporting base 30 of a generally rigid form and supported by a bottom surface 32. The bottom surface 32 is envisioned as being non-slip bottom surface to prevent it from sliding around a desk-top. On the top of the supporting base 30 are a series of captive blocks 34 that bound and form a ball receiving cavity 36. The side retaining surfaces 38 of the captive blocks 34 are inwardly slanted toward the center of the ball receiving cavity 36 such as to form a retaining lip 40 circumscribing the upper opening of each cavity 36. In this manner, the massaging ball 24 is retained within the cavity 36, while remaining free to rotate in any direction and thus users' hands can comfortably glide over the surface of the invention without the usual drag associated with a conventional wrist support pad.

2. Operation of the Preferred Embodiment

In operation, the present invention is used in conjunction with a conventional keyboard. The keyboard is placed within the keyboard holding tray 14 such that the wrist rest 12 is positioned below the keyboard and toward the user. The use of the present invention provides not only wrist support for users of any computer system, but it also provides massaging action as well, which may help reduce the severity of repetitive stress injuries. The present invention also helps keep users hands in an elevated position. Such an elevated hand position reduces injury to wrist and associated muscles, may help reduce or eliminate effects of carpal tunnel syndrome, and increases relaxation and productivity while reducing stress and tension.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The embodiments were chosen and described in order to best explain the principles of the invention and its practical application, to thereby enable others skilled in the art to best utilize the invention and various embodiments with various modifications as are suited to the particular use contemplated. It is intended that the scope of the invention be defined by the claims appended hereto and their equivalents. Therefore, the scope of the invention is to be limited only by the following claims.

What is claimed is:

1. A massaging keyboard wrist rest comprising:
a supporting base structure;
an upper surface having a series of aligned ball access orifices, said upper surface affixed to said base structure such that a plurality of aligned ball receiving cavities are formed at each said ball access orifice; and
series of freely rotatable balls captively held in said ball receiving cavities.

2. The massaging keyboard wrist rest of claim 1, further comprising a bottom surface affixed to said supporting base and forming a non-slip bottom surface.

3. The massaging keyboard wrist rest of claim 1, wherein said upper surface forms a series of captive blocks that bound and form said ball receiving cavity by side retaining surfaces that are inwardly slanted toward the center of said ball receiving cavity such as to form a retaining lip circumscribing said ball access orifices.

4. The massaging keyboard wrist rest of claim 1, further comprising a keyboard holding tray aligned with and extending from said supporting base structure.

5. The massaging keyboard wrist rest of claim 4, wherein said keyboard holding tray is circumscribed by a frame for retaining an otherwise conventional computer keyboard.

6. The massaging keyboard wrist rest of claim 5, wherein said frame comprises a rear fence forming a cord egress channel.

7. The massaging keyboard wrist rest of claim 4, wherein said upper surface forms a series of captive blocks that bound and form said ball receiving cavity by side retaining surfaces that are inwardly slanted toward the center of said ball receiving cavity such as to form a retaining lip circumscribing said ball access orifices.
